(19) United States
(12) Patent Application Publication
(10) Pub. No.: US 2024/0189956 A1
(43) Pub. Date: Jun. 13, 2024

(54) MACHINING SYSTEM WITH FLOW RESTRICTOR FOR SUPERCRITICAL CARBON DIOXIDE-BASED MINIMUM QUANTITY LUBRICATION MACHINING

(71) Applicant: Ford Global Technologies, LLC, Dearborn, MI (US)

(72) Inventors: Richard Earl Williford, Howell, MI (US); Ethan Timothy Hughey, Royal Oak, MI (US); David Alan Stephenson, Detroit, MI (US)

(73) Assignee: Ford Global Technologies, LLC, Dearborn, MI (US)

(21) Appl. No.: 18/079,295

(22) Filed: Dec. 12, 2022

(51) Int. Cl. B23Q 11/10; B23Q 11/12

(52) U.S. Cl. CPC B23Q 11/10; B23Q 11/12

(57) ABSTRACT

A machining system includes a coolant tube assembly including a tubular body, a shoulder, a restrictor, and a sleeve. The tubular body is disposed about a central axis and defines a central bore disposed about the central axis and extending axially from a proximal end of the tubular body toward a distal end of the tubular body. The shoulder extends radially outward from a perimeter surface of the tubular body. The restrictor is coupled to the tubular body and defines at least one aperture extending through the restrictor such that the restrictor is configured to restrict flow from the central bore through the distal end of the tubular body to a flow area of less than 0.126 mm². The sleeve is disposed rotatably about the distal end of the tubular body and defines a male threadform. The sleeve includes a mating shoulder that extends radially inward of the shoulder.

### FIELD

The present disclosure relates to a machining system for supercritical carbon dioxide-based minimum quantity lubrication (MQL) machining.

### BACKGROUND

The statements in this section merely provide background information related to the present disclosure and may not constitute prior art.

Traditional machining lubrication uses high volumes of liquid lubricant to lubricate and cool the working edges of a tool. Some modern machining processes use minimum quantity lubrication (MQL) machining systems that use a lean mixture of oil mist carried by compressed air to lubricate the cutting edges of the tool. While these typical MQL systems work well to reduce oil use and improve cut quality for many applications, for some other applications, such as deep holes in hard materials or when machining bi-metal workpieces, the performance of typical MQL systems can be less than desired.

A new form MQL machining seeks to replace the compressed air with supercritical carbon dioxide at high pressure (e.g., around 100 bar) such that the lubrication fluid is a mixture of supercritical carbon dioxide and oil. However, traditional liquid lubrication systems and even typical MQL systems are not designed to handle this mixture of supercritical carbon dioxide and oil or efficiently provide the mixture to the cutting tool. Furthermore, this form of machining is relatively new such that few machining systems and tools have been developed specifically to handle this mixture of supercritical carbon dioxide and oil. In this regard, the relatively high pressures of these systems can make it difficult to deliver the mixture to the tool. Furthermore, typical supercritical carbon dioxide MQL systems require the use of specialized cutting tools that have coolant exit holes that are less than or equal to 0.4 mm diameter so that the supercritical carbon dioxide expands as it exits the tool at the cutting edges proximate the workpiece. These specialized cutting tools can be difficult and costly to produce.

The teachings of the present disclosure address these and other issues with supercritical carbon dioxide MQL machining.

### SUMMARY

This section provides a general summary of the disclosure and is not a comprehensive disclosure of its full scope or all of its features.

In one form, the present disclosure provides a machining system includes a coolant tube assembly including a tubular body, a shoulder, a restrictor, and a sleeve. The tubular body is disposed about a central axis and defines a central bore disposed about the central axis and extending in a first axial direction from a proximal end of the tubular body toward a distal end of the tubular body. The shoulder extends radially outward from a perimeter surface of the tubular body. The restrictor is coupled to the tubular body and defines at least one aperture extending through the restrictor such that the restrictor is configured to restrict flow from the central bore through the distal end of the tubular body to a flow area of less than 0.126 mm². The sleeve is disposed rotatably about the distal end of the tubular body and defines a male threadform. The sleeve includes a mating shoulder that extends radially inward of the shoulder.

In variations of the machining system according to the above paragraph, which may be implemented individually or in any combination: the restrictor is coupled to the tubular body by at least one of a press-fit into the central bore, a threaded connection, a brazed connection, and a welded connection; the restrictor is disposed closer to the distal end of the tubular body than to the proximal end of the tubular body; the restrictor is a wafer disposed within the central bore and an end of the wafer is flush with or recessed from the distal end of the tubular body; an axial thickness of the wafer is less than or equal to 5 mm; the tubular body and the restrictor are formed of the same material; the restrictor is formed of aluminum or stainless steel; the at least one aperture consists of a single aperture having a diameter between 0.250 mm and 0.400 mm; the central bore is a diameter between 7 mm and 8 mm; the coolant tube assembly further includes a first seal in contact with the sleeve, the tubular body, and a side of the shoulder that faces in the first axial direction; the coolant tube assembly further includes a second seal, the second seal being in contact with the sleeve, the tubular body, and a side of the shoulder that faces in a second axial direction that is opposite the first axial direction; the machining system further comprises a tool holder body including a driven portion and a tool receiving portion, the tool holder body defining a first female threadform configured to mate with the male threadform of the sleeve; the machining system further comprises an adjustment screw, wherein the tool holder body defines a second female threadform threadably engaged with a male threadform defined by the adjustment screw, the adjustment screw defining a seat surface configured to contact a mating surface of a tool inserted in the tool receiving portion, the adjustment screw defining a central passageway coaxial with the central axis; a maximum distance between an outlet of the aperture of the restrictor and an inlet of the central passageway of the adjustment screw is less than 100 mm; the machining system further comprises a spindle and a lubrication system, the spindle being coupled to the tool holder body and configured to rotate the tool holder body about the central axis, the lubrication system configured to supply a lubricant to the interior of the tubular body such that the lubricant flows from the interior of the tubular body through the aperture of the restrictor to the central passageway in the adjustment screw; the lubrication system includes a supply tube disposed about the central axis and a seal is formed between the supply tube and a radially outward surface of the tubular body; the lubricant provided by the lubrication system is a mixture of supercritical carbon dioxide and oil.

In another form, the present disclosure provides a machining system including a coolant tube assembly including a tubular body, a shoulder, a restrictor, and a sleeve. The tubular body is disposed about a central axis and defines a central bore disposed about the central axis and extending in a first axial direction from a proximal end of the tubular body toward a distal end of the tubular body. The shoulder extends radially outward from a perimeter surface of the tubular body. The restrictor is disposed within the central bore and defines a single aperture extending through the restrictor and having a diameter between 0.250 mm and 0.400 mm. The sleeve is disposed rotatably about the distal end of the tubular body and defines a male threadform. The sleeve includes a mating shoulder that extends radially inward of the shoulder of the tubular body.

In a variation of the machining system according to the above paragraph, the restrictor is disposed closer to the distal end of the tubular body than to the proximal end of the tubular body and an end of the restrictor is flush with or recessed from the distal end of the tubular body.

In yet another form, the present disclosure provides a coolant tube for a tool holder of a machining system. The coolant tube includes a tubular body, a shoulder, a wafer, and a sleeve. The tubular body is disposed about a central axis and defines a central bore disposed about the central axis and extending in a first axial direction from a proximal end of the tubular body toward a distal end of the tubular body. The central bore has a diameter between 7 mm and 9 mm. The shoulder extends radially outward from a perimeter surface of the tubular body. The wafer is fixed within the central bore of the tubular body and has an axial thickness of less than 5 mm. The wafer defines a single aperture extending axially through the wafer. The single aperture has a diameter between 0.250 mm and 0.400 mm. The sleeve is disposed rotatably about the distal end of the tubular body and defines a male threadform. The sleeve includes a mating shoulder that extends radially inward of the shoulder of the tubular body.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a cross-sectional view of a machining system according to the teachings of the present disclosure;

FIG. 2 is a cross-sectional view of a portion of a tool holder of the machining system of FIG. 1, illustrating a coolant tube assembly and an adjustment screw of the tool holder; and

FIG. 3 is a cross-sectional view of a portion of the tool holder of the machining system of FIG. 1, illustrating a restrictor of the coolant tube assembly and an end of the adjustment screw.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

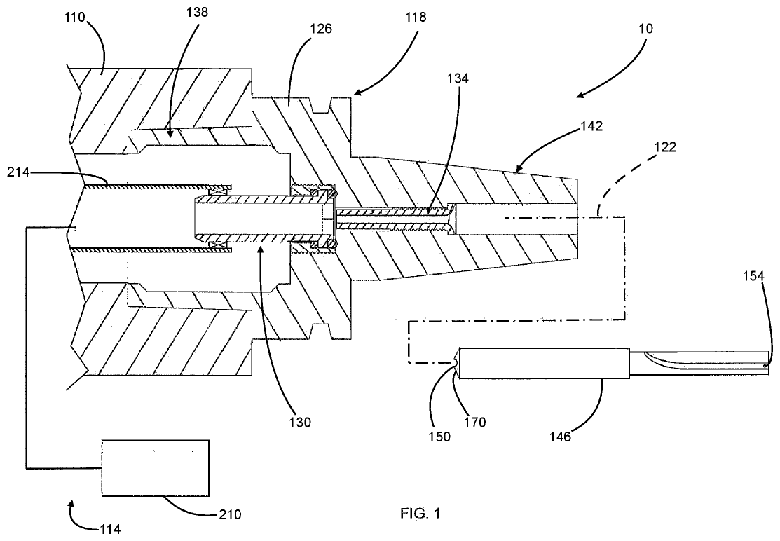

Referring to FIG. 1, a machining system 10 is illustrated. In the example provided, the machining system 10 is a multi-axis mill, though other types of machining systems can be used (e.g., a lathe or drill press). The machining system 10 generally includes a spindle 110, a lubricant system 114, and a tool holder 118. The spindle 110 is supported for rotation about a central axis 122 and is drivingly coupled to a motor (not shown) configured to rotate the spindle 110 about the axis 122. The tool holder 118 includes a tool holder body 126, a receiver or coolant tube assembly 130, and an adjustment screw 134.

A driven portion 138 of the tool holder body 126 is coupled to the spindle 110 for common rotation about the axis 122 and a tool receiving portion 142 is configured to hold a tool 146 to rotate the tool 146 about the axis 122. The tool 146 can be any suitable tool such as a drill bit or milling tool, for example, and has internal passages (not specifically shown) that connect an inlet 150 at one end of the tool 146 to at least one outlet 154 at the opposite end of the tool 146, proximate the cutting edges of the tool 146, for fluid communication therebetween.

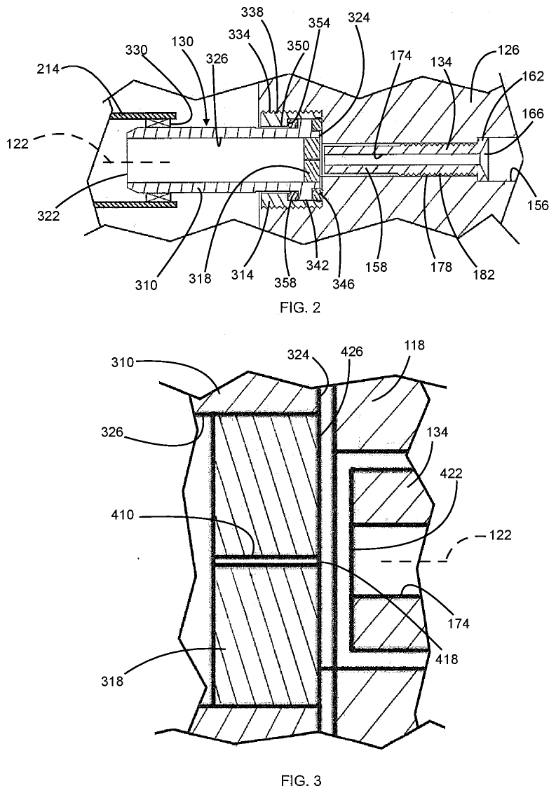

With additional reference to FIG. 2, the adjustment screw 134 is disposed within a central bore 156 of the tool holder body 126 and includes a shaft 158 and a seat 162. The seat 162 is disposed within a forward portion of the central bore 156, within which the tool 146 (FIG. 1) is receivable. The seat 162 includes a seat surface 166 that faces axially forward and is configured to form a seal with a mating surface 170 (FIG. 1) of the tool 146 such that a bore 174 defined through the adjustment screw 134 is in fluid communication with the inlet 150 of the tool 146.

In the example provided, the seat surface 166 and the mating surface 170 are frustoconical, though other configurations can be used, such as flat shaped for example. In the example provided, the bore 174 is a singular bore centered on the axis 122, though other configurations can be used, such as being offset from the axis 122 and/or having a plurality of bores disposed about the axis 122 for example.

The shaft 158 defines an exterior threadform 178 disposed about the axis 122 and threadably engaged with an interior threadform 182 defined by within a rear portion of the central bore 156 of the tool holder body 126. The engagement between the threadforms 178, 182 permits the axial position of the seat 162 to be adjusted. In one form, the bore 174 can be entirely or partially shaped as a square or hexagonal shape such that an adjustment tool (not shown) can be inserted into the central bore 156 to engage the adjustment screw 134 to adjust the axial position by rotation relative to the tool holder body 126.

In the example provided, the seat 162 is disposed in a portion of the central bore 156 that has a greater diameter than the portion in which the shaft is received, though other configurations can be used.

Referring to FIG. 1, the lubricant system 114 includes a lubricant source 210 coupled to a supply tube or conduit 214 within the spindle 110 for fluid communication therewith. The lubricant source 210 is configured to provide a mixture of supercritical carbon dioxide and oil to the conduit 214. In the example provided, the conduit 214 rotates with the spindle 110 and is connected to the lubricant source 210. In an alternative configuration, the conduit 214 can be rotationally stationary while the spindle 110 rotates about it.

Referring to FIG. 2, the coolant tube assembly 130 includes a tubular body 310, a sleeve 314, and a restrictor 318. The tubular body 310 is disposed about the axis 122 and extends axially from a rear end 322 to a forward end 324 of the tubular body 310. The tubular body defines a tube bore 326 centered on the axis 122. The conduit 214 is sealingly coupled to the tubular body 310 proximate (i.e., closer to) the rear end 322 such that the conduit 214 is in fluid communication with the tube bore 326. In the example provided, the interior diameter of the conduit 214 is greater than an exterior diameter of the tubular body 310 and a seal 330 is disposed therebetween to sealingly couple the conduit 214 to the tubular body 310, though other configurations can be used, such as the conduit sealing against an end surface of the tubular body 310 or being sealingly received within the tube bore 326, for example.

In the example provided, the tube bore 326 is between 7 mm and 8 mm in diameter, though other configurations can be used. In the example provided, the tube bore 326 provides a constant diameter flow path from the rear end 322 to the restrictor 318, though other configurations can be used.

The sleeve 314 couples the tubular body 310 to the tool holder body 126. The sleeve 314 is disposed about the tubular body 310 proximate the forward end 324. In the example provided, the sleeve 314 has an external threadform 334 that is disposed about the axis 122 and threadably engaged with an internal threadform 338 defined by the tool holder body 126 in a portion of the central bore 156 that is rearward of the portion where the shaft 158 is disposed. In the example provided, the portion of the central bore 156 including the internal threadform 338 has a greater diameter than the portion in which the shaft 158 is disposed.

In the example provided, the tubular body 310 includes a shoulder 342 that extends about the circumference of the tubular body 310 proximate to the forward end 324 and a seal 346 (e.g., O-ring) disposed about the tubular body 310 on a forward side of the shoulder 342. The sleeve 314 defines a bore 350 that is open through the forward and rearward ends of the sleeve 314. A forward portion of the bore 350 has a greater diameter than the shoulder 342 and the bore 350 steps down in diameter at a shoulder 354 that extends radially inward of the shoulder 342. In this way, rotating the sleeve in a tightening direction of the threadforms 334, 338 compresses the seal 346 between the shoulder 342 and a step of the tool holder body 126 to form a seal therebetween. In the example provided, a second seal 358 (e.g., O-ring) may optionally be disposed between the shoulders 342, 354 to provide a seal therebetween.

Referring to FIG. 3, the restrictor 318 is coupled to the tubular body 310 proximate the forward end 324 (i.e., closer to the forward end 324) and is configured to restrict flow from the tube bore 326 out of the forward end 324. The restrictor 318 defines at least one throttling bore 410 extending axially through the restrictor 318 and having a total cross-sectional flow area (i.e., taken perpendicular to axis 122) of less than 0.126 mm². In the example provided, the restrictor 318 defines a single throttling bore 410 that is a diameter of between 0.250 mm and 0.400 mm. In one form, the diameter of the throttling bore 410 is 0.3 mm, though other sizes less than 0.4 mm may be used. In the example provided, the single throttling bore 410 is centered on the axis 122, though other configurations can be used, such as being offset therefrom. In another form, not specifically shown, the restrictor 318 defines a two or more throttling bores having a total cross-sectional flow area of less than 0.126 mm².

In the example provided, the restrictor 318 is a wafer that is separate piece of material than the tubular body 310 and is attached to the tubular body 310 within the tube bore 326. In one form, the restrictor 318 may be press-fit into the tube bore 326. In another form, the restrictor 318 may have a shrink fit. In another form, the restrictor 318 may be brazed or welded in place within the tube bore 326. In yet another form, an adhesive material, epoxy, or the like may hold the restrictor 318 in the tube bore 326. In still another form, the restrictor 318 and tube bore 326 may have mating threadforms that couple the two components together. In yet a further form, the restrictor 318 may be external to the tube bore 326 and be mounted to the forward end 324 such as by brazing or welding for example.

In still another form, not shown, the restrictor 318 may be integrally formed with the tubular body 310. For example, the tube bore 326 may be formed such that it does not extend fully through the forward end 324, then the throttling bore 410 may be formed from the tube bore 326 through the forward end 324.

In the example provided, the restrictor 318 is less than or equal to 5 mm thick in the axial direction (i.e., axial direction of axis 122). In one form, the restrictor 318 is 3 mm thick in the axial direction, though other thicknesses may be used.

In one form, the throttling bore 410 may be formed by drilling. In another form, the throttling bore 410 may be formed by wire electro discharge machining (EDM).

In one form, the restrictor 318 is the same type of material as the tubular body 310. For example, the restrictor 318 and the tubular body 310 and restrictor 318 may both be steel, stainless steel, aluminum, or another suitable material. In another form, the restrictor 318 is a different type of material than the tubular body 310. For example, the restrictor 318 may be aluminum while the tubular body 310 is steel for example, though other combinations of materials may be used. However, it should be appreciated that the restrictor 318 must be made of a material suitable to exposure to supercritical carbon dioxide at relatively high pressures (e.g., 100 bar or 10,000 kPa) without damage to the structure of the restrictor 318 or fouling of the throttling bore 410 such as due to corrosion.

The restrictor 318 is positioned such that an outlet 418 of the throttling bore 410 is axially spaced apart from an inlet 422 of the bore 174 of the adjustment screw 134. The diameter of the bore 174 is greater than that of the throttling bore 410, such that the supercritical carbon dioxide MQL fluid expands as it exits the throttling bore 410 and enters the bore 174. In one form, the bore 174 can be in the range of 2.9 mm to 5.4 mm, though other sizes of the bore 174 can be used. In one form, the space between the outlet 418 and the inlet 422 is less than 100 mm. In the example provided, having this space be greater than 100 mm can allow the supercritical carbon dioxide MQL fluid to expand too much before entering the tool 146 (FIG. 1) and, thus, waste some of the cooling capacity of the supercritical carbon dioxide MQL fluid by cooling the tool holder 118 rather than the tool 146 (FIG. 1).

In the example provided, a forward end 426 of the restrictor 318 is flush with the forward end 324 of the tubular body 310. In another form, the forward end 426 can be recessed axially rearward of the forward end 324, though still within 100 mm of the inlet 422. In still another form, the forward end 426 may be forward of the forward end 324 of the tubular body 310, though care should be taken not to contact the tool holder body 126 or adjustment screw 134.

The present disclosure also includes a method of modifying a typical liquid lubricant machining system for operation with supercritical carbon dioxide MQL. In this form, the conduit 214, tool holder body 126, seal 330, tubular body 310, sleeve 314, seals 346, 358, and adjustment screw 134 can be components from existing, typical liquid lubricant systems and can be modified by inserting the restrictor 318 into the tube bore 326 or otherwise attaching the restrictor 318 to the forward end 324 of the tubular body 310. This relatively inexpensive modification has the unexpected and surprising result of permitting existing system components (i.e., those that have relatively large lubricant bores designed specifically for liquid lubricant) to be converted to supercritical carbon dioxide MQL use. Additionally, it has been found to be particularly unexpected how the relatively small diameter of the throttling bore 410 can effectively permit a typical liquid lubricant system to be used with supercritical carbon dioxide MQL despite the throttling bore 410 only extending a relatively short length (e.g., less than 5 mm) in the total flow path of the larger lubricant pathway when the restrictor 318 is specifically positioned in the tubular body 310 such that the outlet 418 of the throttling bore 410 is within 100 mm of the inlet 422 of the adjustment screw 134.

As such, the present disclosure provides a machining system for use with supercritical carbon dioxide MQL machining which improves efficiencies and quality for certain machining applications. While the present disclosure refers to machining systems for use with supercritical carbon dioxide, the teachings of the present disclosure can also be used with other supercritical MQL mixtures or cryogenic MQL mixtures (e.g., liquid nitrogen and oil).

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A machining system comprising:
a coolant tube assembly comprising:
a tubular body disposed about a central axis and defining a central bore disposed about the central axis and extending in a first axial direction from a proximal end of the tubular body toward a distal end of the tubular body;
a shoulder extending radially outward from a perimeter surface of the tubular body;
a restrictor coupled to the tubular body and defining at least one aperture extending through the restrictor such that the restrictor is configured to restrict flow from the central bore through the distal end of the tubular body to a flow area of less than 0.126 mm²; and
a sleeve disposed rotatably about the distal end of the tubular body and defining a male threadform, the sleeve including a mating shoulder that extends radially inward of the shoulder.

2. The machining system of claim 1, wherein the restrictor is coupled to the tubular body by at least one of a press-fit into the central bore, a threaded connection, a brazed connection, and a welded connection.

3. The machining system of claim 1, wherein the restrictor is disposed closer to the distal end of the tubular body than to the proximal end of the tubular body.

4. The machining system of claim 3, wherein the restrictor is a wafer disposed within the central bore and an end of the wafer is flush with or recessed from the distal end of the tubular body.

5. The machining system of claim 4, wherein an axial thickness of the wafer is less than or equal to 5 mm.

6. The machining system of claim 1, wherein the tubular body and the restrictor are formed of the same material.

7. The machining system of claim 1, wherein the restrictor is formed of aluminum or stainless steel.

8. The machining system of claim 1, wherein the at least one aperture consists of a single aperture having a diameter between 0.250 mm and 0.400 mm.

9. The machining system of claim 1, wherein the central bore is a diameter between 7 mm and 8 mm.

10. The machining system of claim 1, wherein the coolant tube assembly further includes a first seal in contact with the sleeve, the tubular body, and a side of the shoulder that faces in the first axial direction.

11. The machining system of claim 1, wherein the coolant tube assembly further includes a second seal, the second seal being in contact with the sleeve, the tubular body, and a side of the shoulder that faces in a second axial direction that is opposite the first axial direction.

12. The machining system of claim 1, further comprising a tool holder body including a driven portion and a tool receiving portion, the tool holder body defining a first female threadform configured to mate with the male threadform of the sleeve.

13. The machining system of claim 12, further comprising an adjustment screw, wherein the tool holder body defines a second female threadform threadably engaged with a male threadform defined by the adjustment screw, the adjustment screw defining a seat surface configured to contact a mating surface of a tool inserted in the tool receiving portion, the adjustment screw defining a central passageway coaxial with the central axis.

14. The machining system of claim 13, wherein a maximum distance between an outlet of the aperture of the restrictor and an inlet of the central passageway of the adjustment screw is less than 100 mm.

15. The machining system of claim 13, further comprising a spindle and a lubrication system, the spindle being coupled to the tool holder body and configured to rotate the tool holder body about the central axis, the lubrication system configured to supply a lubricant to an interior of the tubular body such that the lubricant flows from the interior of the tubular body through the aperture of the restrictor to the central passageway in the adjustment screw.

16. The machining system of claim 15, wherein the lubrication system includes a supply tube disposed about the central axis and a seal is formed between the supply tube and a radially outward surface of the tubular body.

17. The machining system of claim 15, wherein the lubricant provided by the lubrication system is a mixture of supercritical carbon dioxide and oil.

18. A machining system comprising:
a coolant tube assembly comprising:
a tubular body disposed about a central axis and defining a central bore disposed about the central axis and extending in a first axial direction from a proximal end of the tubular body toward a distal end of the tubular body;
a shoulder extending radially outward from a perimeter surface of the tubular body;
a restrictor disposed within the central bore and defining a single aperture extending through the restrictor and having a diameter between 0.250 mm and 0.400 mm; and
a sleeve disposed rotatably about the distal end of the tubular body and defining a male threadform, the sleeve including a mating shoulder that extends radially inward of the shoulder of the tubular body.

19. The machining system of claim 18, wherein the restrictor is disposed closer to the distal end of the tubular body than to the proximal end of the tubular body and an end of the restrictor is flush with or recessed from the distal end of the tubular body.

20. A coolant tube for a tool holder of a machining system, the coolant tube comprising:
a tubular body disposed about a central axis and defining a central bore disposed about the central axis and extending in a first axial direction from a proximal end of the tubular body toward a distal end of the tubular body, the central bore having a diameter between 7 mm and 9 mm;
a shoulder extending radially outward from a perimeter surface of the tubular body;
a wafer fixed within the central bore of the tubular body and having an axial thickness of less than 5 mm, the wafer defining a single aperture extending axially through the wafer, the single aperture having a diameter between 0.250 mm and 0.400 mm; and
a sleeve disposed rotatably about the distal end of the tubular body and defining a male threadform, the sleeve including a mating shoulder that extends radially inward of the shoulder of the tubular body.
